(19) United States
(12) Patent Application Publication
(10) Pub. No.: US 2004/0146677 A1
(43) Pub. Date: Jul. 29, 2004

(54) Flexible reflective sleeve

(75) Inventor: William C. Boyd, White Bear Lake, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/350,431

(22) Filed: Jan. 24, 2003

(51) Int. Cl. B32B 1/08

(52) U.S. Cl. 428/36.91

(57) ABSTRACT

The present invention discloses a reflective sleeve for application to a support comprising a flexible substrate having a viewing surface and a non-viewing surface and at least one reflective band bonded to a flexible substrate wherein a portion of the flexible substrate is exposed on the viewing surface.

### FIELD OF THE INVENTION

The invention relates to a reflective (e.g. retroreflective) sleeve and a method of making a reflective sleeve. The sleeve is typically applied to a support such as a cone or coil forming a traffic device.

### BACKGROUND OF THE INVENTION

Traffic devices are used to channel traffic, divide opposing traffic lanes, divide traffic lanes when two or more lanes are kept open in the same direction, and delineate the boundaries of temporary maintenance and utility work zones. The term “traffic device” includes, but is not limited to, bodies such as cones that are integrally formed from a flexible material that can be struck by a moving vehicle without significantly damaging the vehicle on impact, and having a base portion for supporting an upright member, preferably a conical or cylindrical member. Examples of traffic devices include cones, drums, tubes, stakes, posts, and roll-up signs.

A common method of enhancing the visibility of such a traffic device, such as a traffic cone, is to adhesively apply reflectorized sheeting material to the exterior of the upright member in order to enhance the visibility of the traffic cone at night or other times of poor visibility. Typically, traffic cones for use on freeways include one or more reflective bands, which typically are formed from reflective sheeting, preferably retroreflective sheeting, adhered to the cone.

Some exemplary patents pertaining to such traffic devices include as follows: WO 99/24671 (Boyd) describes a multicolor sleeve formed as a piece of retroreflective sheeting having an upper and lower band of one color. A central area of a second color, either a transparent ink, a transparent film, or a retroreflective film, is applied to the surface of the retroreflective sheeting to form precisely spaced bands of color. The retroreflective sheeting can be formed into a sleeve and the sleeve then applied and bonded in a single step onto a conical-shaped or cylindrical shaped traffic device. WO 02/34855 (Boyd) describes adhesive article and method of applying and activating adhesive article to bond substrates using a fluid application aid. Preferably, the substrates are traffic devices such as traffic cones and the adhesive article are retroreflective cone collars or sleeves.

U.S. Pat. No. 5,236,751 (Martin) describes a relatively flexible retroreflective band for adhesive bonding about a support structure comprises a length of retroreflective sheeting formed into a continuous band with the outer portion of the band including retroreflective formations adapted to retroreflect light rays impinging thereon. An adhesive coating is disposed on the inner surface of the band to bond the band to a support structure, and a water-soluble release coating is superposed on the adhesive coating to prevent substantially contact of the adhesive coating with other surfaces. When it is desired to assemble the band onto a support structure, water is applied to dissolve the release coating and, while the adhesive coating is still wet with water, the band is slid over the support structure to the desired position.

Recently, a retractable traffic cone has been marketed by Worldwide Safety Incorporated, Sacramento, Calif. under the trade designation “Flexible Marker Device”. Such retractable traffic cone has a coil having a conical-shape upon extension and a conical-shaped fluorescent orange mesh sleeve covering the coil. Such retractable traffic cones are advantageous over conventional cones comprised of molded polyvinyl chloride due to being more forgiving upon impact and take less space to store. However, when attempting to bond retroreflective cone collars to these retractable traffic cones, it was found that the cone collars were too rigid, impairing the ability of the cone to properly retract.

### SUMMARY OF THE INVENTION

The present invention discloses a reflective sleeve for application to a support comprising a flexible substrate having a viewing surface and a non-viewing surface and at least one reflective band bonded to a flexible substrate wherein a portion of the flexible substrate is exposed on the viewing surface. The reflective band is preferably at least as flexible as the flexible substrate. The reflective band may be substantially free of backing such as wherein the reflective band consists essentially of microspheres at least partially embedded in a binder layer and specular or diffuse reflecting material. The reflective band may further comprise a fabric backing. The reflective film may be a transfer film and thus comprise an adhesive that is heat activated.

In one embodiment, the reflective sleeve is triangular shaped having a base arcuate edge and optional top arcuate edge and a pair of side edges. Upon joining the side edges a conical shape is formed.

In another embodiment, the reflective sleeve is rectangular having two pairs of parallel edges. The rectangular reflective sleeve may be attached to a roll-up sign support or to a traffic sign for use as a sign mask. For other uses a pair of opposing edges are joined such that a cylindrical shape is formed.

During use the sleeves are combined with a support such as cones, drums, tubes, stakes, posts, coils, sign supports, and traffic signs.

In another embodiment, the invention discloses a method of making a reflective sleeve comprising providing a flexible substrate, providing at least one reflective band, and bonding the band to the flexible substrate. The flexible substrate is preferably a triangular or cylindrical shape prior to or after bonding of the reflective bands.

### BRIEF DESCRIPTION OF THE DRAWINGS

The invention will be further explained with reference to the drawings, wherein:

FIG. 1 is a perspective view of an exemplary embodiment of the present invention depicting a triangular shaped sleeve.

FIG. 2 is a perspective view showing the sleeve of FIG. 1 placed onto a conical-shaped support.

FIG. 3 is a perspective view of an exemplary rectangular sleeve of the present invention.

FIG. 4 is a perspective view showing the sleeve of FIG. 3 placed on a cylindrical-shaped traffic device.

FIG. 5 is a perspective view of an exemplary cone collar of the present invention prior to application to a support.

These figures, which are idealized, are not to scale and are intended to be merely illustrative and non-limiting.

### DETAILED DESCRIPTION OF THE INVENTION

The present invention relates to reflective (e.g. retroreflective) sleeves and methods of making reflective sleeves. During end use, the sleeves are preferably applied to, placed upon, or attached to a support.

As used herein “sleeve” refers to an outer covering for a support. Prior to joining two of the edges of the sleeve, the sleeve is a laminate having for example a triangular of rectangular shape. The laminate is typically continuous in both the length and width. The laminate may be employed in conjunction with a two-dimensional support such as for example a roll-up sign support. For embodiments wherein the sleeve is employed in conjunction with three-dimensional support, two opposing edges of the sleeve are joined such that the sleeve has one to two openings. Conventional cone collars, traffic markers, and traffic barrel sleeves typically comprise two openings such that the support is exposed on either side of each opening with the sleeve positioned in the middle area of the support. Other sleeves, for example sleeves for retractable traffic devices (e.g. cones) typically have a single opening for receipt of the support.

The sleeves of the present invention comprise a flexible substrate (e.g. fabric) and at least one flexible reflective or retroreflective band. The reflective bands are about equal in flexibility or more flexible than the flexible substrate. The flexibility of the band can be evaluated according to ASTM D 882 with a crosshead speed of 20 inches/min and 2 inch initial grip separation. As used herein “flexible” with respect to the band refers to having an elongation at break of at least 100%. Preferably the elongation at break is at least 200%, more preferably at least 300%, even more preferably at least 400%, and even more preferably about 500%.

The sleeves will be described herein with reference to exemplary preferred embodiments wherein the sleeves are suitable for retroreflective traffic device articles.

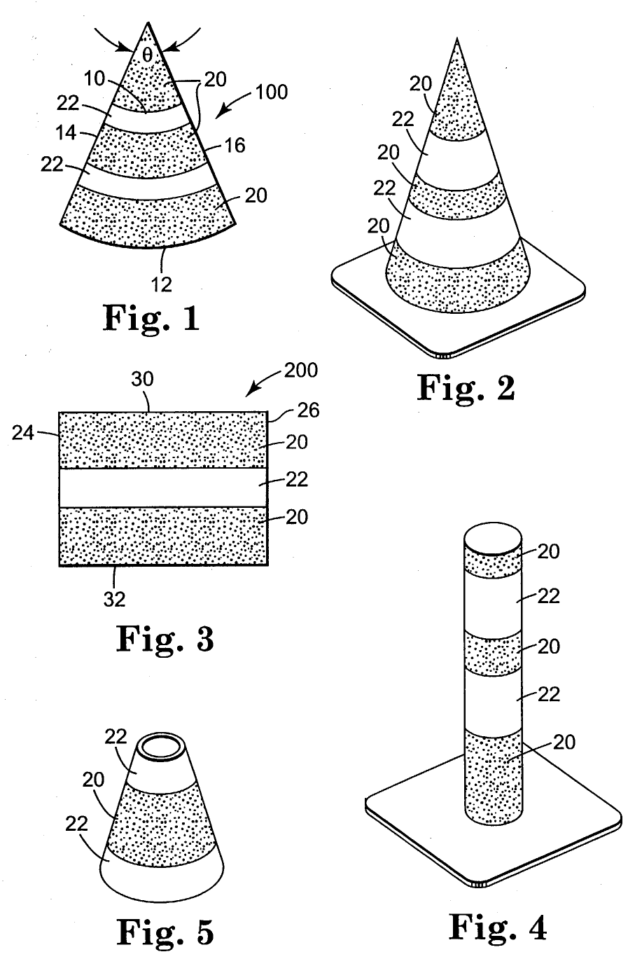

With reference to FIG. 1, in one exemplary embodiment the present invention is a triangular-shaped sleeve 100 comprising a flexible substrate (e.g. fabric mesh) 20 and at least one, and preferably two reflective bands 22 bonded to the viewing surface of the fabric. The substrate comprises a base arcuate edge 12 and optional top arcuate edge parallel to the base arcuate edge and a pair of side edges. The edges (e.g. 10) of the reflective bands are also arcuate. The reflective sleeve preferably comprises at least two bands 22 aligned substantially parallel with the base arcuate edge. Upon joining the side edges 14 and 16 to each other a conical shape is formed. Side edges 14 and 16 form an included angle φ, which for cones is generally at least about 30 degrees and often much larger depending on the pitch of the cone.

The cone-shaped sleeve is provided on the outer viewing surface of a cone-shaped support such as shown in FIG. 2. The edges (i.e. 14 and 16) may be joined (e.g. sewn seam) before application to the support. This is preferred for embodiments wherein the support is for example a retractable coil. For conventional traffic devices (e.g. conventional cones and barrels molded from polyvinyl chloride) the suitably shaped flexible fabric comprising the reflective band(s) may be applied to the support concurrent with the joining of edges 14 and 16.

With reference to FIG. 3, in another exemplary embodiment the present invention is a rectangular-shaped sleeve 200 comprising a flexible substrate 20 and at least one, and preferably two reflective bands 22 bonded to the viewing surface of the fabric. The sleeve generally comprises a pair of peripheral parallel edges (e.g. first pair having edges 24 and 26 and second pair having edges 30 and 32, each pair typically being straight and equal in length. Upon joining side edges 24 and 26 a cylindrical shaped sleeve is formed suitable as an outer cover for a cylindrical-shaped support as depicted in FIG. 4.

FIG. 5 is an exemplary cone collar in accordance with the present invention.

The retroreflective bands may be positioned in any arrangement. Further, the bands may be of the same or different including a variety of colors. Some preferred designs are described in International Application No. WO 99/24671 (published May 20, 1999), incorporated herein by reference. Preferably, however, two bands are positioned in the approximate mid-section of the sleeve as depicted in FIGS. 1-2 and 4. The cone collar of FIG. 5 includes an upper band and a lower band, each band comprising a common peripheral edge with the flexible substrate and a central area of the exposed flexible substrate that divides the upper band and the lower band. The sleeve may also include additional bands above the upper band or below the lower band.

In forming the sleeve (e.g. cone collar), the opposing side edges may be overlapped, spliced so that the edges meet to form a butt joint, or placed so that the edges do not contact each other, but are in close proximity. For instance wherein the edges are in close proximity, the distance in separation is typically less than 1 cm. Such separation is not considered an “opening”. Alternately, fastening means may be used to hold the sleeve edges in juxtaposition. Both mechanical and/or chemical fastening means may be used to hold the sleeve edges in a wrapped condition prior to placement onto the cone. Chemical means include for example double stick tape, pressure-sensitive adhesives, and thermal adhesives. Mechanical means include as examples stitching, staples, rivets, brackets, hooks, and hook and loop fasteners. Other fastening means include welding techniques. For instances wherein the flexible substrate is a mesh-like fabric having a plurality of small openings, a heat activated adhesive (e.g. polyurethane based) is preferred. Further, with the exception of sewing, mechanical fastening means are less desired than chemical means due to the tendency of such fastening devices to reduce the flexibility of the sleeve such that collapsing upon itself is impaired. Further, mechanical fastening means such as staple and rivets may have a tendency to pierce holes in the flexible substrate of the sleeve.

The thickness of the flexible substrate typically ranges from about 0.025 mils to about 0.10 mils. The flexible substrate may be reflective, retroreflective or non-reflective, yet is typically different in appearance than the bands either in color and/or reflective properties. Preferably the flexible substrate is stretchable. The flexible substrate preferably comprises a fabric. The fabric may be woven, knit, or non-woven. Non-woven fabrics are suitable for uses wherein extended durability of the sleeve is not needed. For traffic devices the fabric is typically woven or knit and comprised of a durable polymeric material. Polyester, nylon, polyvinyl chloride as well as natural fibers such as cotton may be employed including blends of such fibers. For improved stretchability, the fabric may comprise elastomeric fibers as well. In the case of retractable traffic devices (e.g. cones), the fabric typically comprises a mesh or mesh-like material. The multitude of openings increases the flexibility of the sleeve as well as allows wind to blow through the sleeve. Alternatively, the flexible substrate may be a flexible film such as polyvinyl chloride, polyurethane, and neoprene rubber.

The thickness of the reflective bands generally ranges from about 0.0025 mils to about 0.050 mils. Preferably the thickness is less than 0.005 mils. Further, the bands may be in the form of letters or symbols. The reflective bands may be provided in the form of retroreflective sheeting. The two most common types of retroreflective sheeting suitable for use are microsphere-based sheeting and cube corner-based sheeting. Microsphere sheeting, sometimes referred to as “beaded sheeting,” is well known to the art and includes a multitude of microspheres typically at least partially embedded in a binder layer, and associated specular or diffuse reflecting materials (such as metallic vapor or sputter coatings, metal flakes, or pigment particles). There are also “slurry coated” and lens-based sheetings in which the beads are in spaced relationship to the reflector but in full contact with resin. There are also “exposed lens” retroreflective sheetings in which the reflector is in direct contact with the bead but the opposite side of the bead is in a gas interface. Illustrative examples of microsphere-based sheeting are disclosed in U.S. Pat. No. 4,025,159 (McGrath); U.S. Pat. No. 4,983,436 (Bailey); U.S. Pat. No. 5,064,272 (Bailey); U.S. Pat. No. 5,066,098 (Kult); U.S. Pat. No. 5,069,964 (Tolliver); and U.S. Pat. No. 5,262,225 (Wilson).

Cube corner sheeting, sometimes referred to as prismatic, microprismatic, or triple mirror reflector sheetings, typically includes a multitude of cube corner elements to retroreflect incident light. Cube corner retroreflectors typically include a sheet having a generally planar front surface and an array of cube corner elements protruding from the back surface. Cube corner reflecting elements include generally trihedral structures which have three approximately mutually perpendicular lateral faces meeting in a single corner—a cube corner. In use, the retroreflector is arranged with the front surface disposed generally toward the anticipated location of intended observers and the light source. Light incident on the front surface enters the sheet and passes through the body of the sheet to be totally internally reflected by the faces of the elements, so as to exit the front surface-in a direction substantially toward the light source. The light rays are typically reflected at the lateral faces due to total internal reflection, or by reflective coatings, as previously described, on the back side of the lateral faces. The cube corner-based retroreflective sheeting for use in the invention is “flexible,” “conformable,” or “embossable”. Illustrative examples of such sheeting are disclosed in U.S. Pat. No. 5,138,488 (Szczech); U.S. Pat. No. 5,387,458 (Pavelka); U.S. Pat. No. 5,450,235 (Smith); U.S. Pat. No. 5,605,761 (Burns); U.S. Pat. No. 5,614,286 (Bacon); U.S. Pat. No. 5,066,098 (Kult et al.); and U.S. Pat. No. 4,896,943 (Tolliver et al.).

The coefficient of retroreflection of the retroreflective sleeve varies depending on the desired properties of the finished article. In general, however, the retroreflective sleeve typically has a coefficient of retroreflection ranging from about 5 to about 1500 candelas per lux per square meter at 0.2 degree observation angle and −4 degree entrance angle, as measured according to ASTM E-810 test method for coefficient of retroreflection of retroreflective sheeting. The coefficient of retroreflection is preferably at least 10, more preferably at least 15, and even more preferably at least 20 candelas per lux per square meter. Typically traffic devices, have a coefficient of retroreflection of at least 100 candelas per lux per square meter and preferably at least 200 candelas per lux per square meter. Preferably, the retroreflective sleeve has a retroreflectivity under wet or rainy conditions of not less than 70% of its retroreflectivity under dry conditions. Further description of retroreflection and retroreflective sheeting is found in “Standard Specification for Retroreflective Sheeting for Traffic Control” ASTM D 4956-94 (November 1994).

Unlike the retroreflective sheeting formerly employed for making cone collars, in the present invention the retroreflective sheeting is preferably substantially free of a backing and substantially free of a top film, particularly those backings and top films that reduce the flexibility of the sheeting. In such embodiments the retroreflective layer preferably consists essentially and more preferably solely of a multitude of microspheres typically at least partially embedded in a binder layer and an associated specular or diffuse reflecting material. Such reflective materials are commercially available from 3M Company (“3M”), St. Paul, Minn. under the trade designation “Scotchlite Reflective Material Transfer Film” in a variety of colors (e.g. silver, white, fluorescent orange, fluorescent yellow). “Scotchlite Reflective Material Transfer Film 8710” (“8710”) conveniently includes a heat-activated polyurethane adhesive. This material has a silver color when viewed during daylight and a white reflected color. The coefficient of retroreflection (R_{A}) averages 500 candelas per lux per square meter with a minimum of 330 when measured according to ASTM E810 at an entrance angle of −4.0° and observation angle 0.2°. Further, the coefficient of retroreflection (R_{A}) averages 300 with a minimum of 250 candelas per lux per square meter when measured according to ASTM E810 at an entrance angle of 5.0° and observation angle 0.33°. Other physical properties of this material include that it may be flexed 7500 cycles employing ISO 7854, Method A, that is it washable 25 cycles at 60° C. with ISO 6330 Method 2A, and that it passes a cold fold evaluation according to ISO 4675.

Alternatively, the retroreflective layer may further comprise a fabric backing. However, such fabric backing is not exposed on the viewing surface of the sleeve. Suitable retroreflective materials that include a fabric backing are commercially available from 3M under the trade designation “Scotchlite Material Fabric 8910” and “Scotchlite Material Fabric 8965”.

The reflective sheets (e.g. “8710”) as well as the flexible substrate (fabric) can be hand cut, die cut, or cut electronically using a computer controlled machine. Volume cutting can be accomplished by methods such as band sawing, roll cutting, or guillotining. Such methods can be used for forming the retroreflective sheeting into pieces having the desired shape for forming sleeves.

The reflective bands are then bonded to the flexible substrate. Bonding the reflective sheeting may involve passing an adhesively coated (e.g. pressure sensitive adhesive, water-based adhesive, solvent-based adhesive) reflective band through a nip of a pair of rolls together with the flexible substrate to apply sufficient pressure to form an adequate bond. Typically the reflective bands can not be removed by hand at ambient temperature from the flexible substrate without tearing the reflective band. For traffic devices, such adhesion is maintained at temperatures ranging from 0° F. to 120° F. Preferably, particularly in the case of mesh-like fabrics a heat-activated adhesive is employed. In such embodiment, the reflective band may be subjected to preheating prior to passage through the rolls, or the rolls may be heated to achieve the necessary activation. Ultrasonic welding, sewing and other bonding techniques are also suitable particularly for embodiments wherein both the flexible substrate and the reflective bands are comprised of fabric or polymeric coated fabric. In the case of adhesive bonding, the band and/or the flexible substrate may comprise pre-applied adhesive. Pre-applied adhesive often is covered with a release liner that is removed prior to bonding. Alternatively, adhesive may be applied to band and/or flexible substrate immediately prior to bonding.

The sleeve having one to two openings is applied to a support. In the case of traffic devices the supports generally have a conical shape or cylindrical shape such as cones, drums, stakes, tubes, and posts. In the case of roll-up signs, the support is typically a sign support such as described in U.S. Pat. Nos. 3,894,707; 4,066,233; 4,094,487; 4,125,240 and 4,211,381. In the case of sign masks that are used to temporary cover a traffic sign, the support is a sign. The support may comprise a polymeric material that is described as being flexible, yet is substantially more rigid than the sleeve, as in the case of conventional cones comprises of polyvinyl chloride for example. The reflective sheeting may be applied manually. One such approach is to place a non-adhesive coated cone collar sleeve over the cone after an adhesive has been applied to the cone, generally by brushing on a liquid adhesive. A second approach is to apply a flat cone sleeve having adhesive coated on it to the cone, i.e. without first bonding the edges (e.g. 14 and 16 of FIG. 1).

Alternatively, a support means may be provided that is suitable for use in combination with the sleeve forming a retractable traffic device. A suitable support means includes a coiled spring that has a conical or cylindrical shape when extended. A retractable traffic cone in the absence of having a reflective band with a coil having a conical-shape upon extension and a conical-shaped fluorescent orange mesh sleeve covering the coil is commercially available from Worldwide Safety Incorporated, Sacramento, Calif. under the trade designation “Flexible Marker Device”.

Illustrative of the present invention is the following example.

### EXAMPLE 1-2

### Preparation of the Sleeves

Retroreflective sheeting commercially available from 3M, St. Paul, Minn. under the trade designation “Scotchlite Reflective Material Transfer Film 8710” was hand cut into two radius bands that measured approximately 4″×23.5″ for the bottom band and 6″×17.5″ for the top band. The “Scotchlite Reflective Material Transfer Film 8710” comprises a microsphere-based adhesive in combination with a polyurethane heat activated adhesive. The bands were applied to a fluorescent vinyl 10 ounce knit mesh fabric product commercially available from Twitchell Company, Dothan, Ala. under the trade designation “K80-636-009” that had been cut into a triangular shape having a height of 31″ tall, a base of 35″ width that tapered to a width of 5″. The two bands were laminated to the vinyl knit mesh as described below.

In Example 1 the bands were laminated to the mesh using a 4′×6′ heat lamp vacuum applicator table set at 220° F. for two minutes with 26 mercury inches of vacuum pressure in combination with a heat press at 250° F. for 15 seconds.

In Example 2 the bands were laminated to the mesh using a standard conveyor oven (10 feet long and set at 265° F.) with a nip roller at the end of the oven (12 seconds dwell time and 5 lbs of pressure).

The bonded pieces could be fabricated into a conical shape by sewing or fastening the longitudinal ends together, thus creating a cone mesh jacket that is retroreflective. The completed cone jacket can be used on a retractable cone or on a standard polyvinyl cone, polyethylene cone or rubber cone.

The flexibility of the band material was evaluated using ASTM D 882 with a crosshead speed of 20 inches/min and 2 inch initial grip separation. The “Scotchlite Reflective Material Transfer Film 8710” was compared to cone collar sheeting commercially available from 3M under the trade designation “Scotchlite Brand High Intensity 3840 Cone Sleeve” (“3840”). The 3840 material was found to be too rigid for use on retractable cones having a coil and a mesh outer sleeve. The results are as follows:

| | 8710 | 3840 |
|---|---|---|
| % Elongation at Break | 550% | 50% |

The results demonstrate that 8710 is significantly more flexible than 3840.

What is claimed is:

1. A reflective sleeve for application to a support comprising a flexible substrate having a viewing surface and a non-viewing surface and at least one reflective band bonded to a flexible substrate wherein a portion of the flexible substrate is exposed on the viewing surface.

2. The reflective sleeve of claim 1 wherein the reflective band is at least as flexible as the flexible substrate.

3. The reflective sleeve of claim 1 wherein the reflective band is substantially free of backing.

4. The reflective sleeve of claim 3 wherein the reflective band consists essentially of microspheres at least partially embedded in a binder layer and specular or diffuse reflecting material.

5. The reflective sleeve of claim 4 wherein the reflective band further comprises a fabric backing.

6. The reflective sleeve of claim 4 wherein the reflective band further comprises an adhesive.

7. The reflective sleeve of claim 6 wherein the adhesive is heat activated.

8. The reflective sleeve of claim 1 wherein the substrate comprises a base arcuate edge and a top arcuate edge parallel to the base arcuate edge and a pair of side edges.

9. The reflective sleeve of claim 8 wherein the reflective sleeve comprises at least two bands aligned substantially parallel with the base and top arcuate edges.

10. The reflective sleeve of claim 8 wherein upon joining the side edges a conical shape is formed.

11. The reflective sleeve of claim 10 wherein the conical shape comprises a single opening about the base arcuate edge.

12. The reflective sleeve of claim 10 wherein the conical shape comprises a pair of openings about each arcuate edge forming a cone collar.

13. The reflective sleeve of claim 12 wherein a first band shares a common edge with the base arcuate edge and a second band shares a common edge with the top arcuate edge and the fabric is exposed between the first and second bands.

14. The reflective sleeve of claim 1 wherein the substrate is rectangular having two pairs of parallel edges.

15. The reflective sleeve of claim 14 wherein upon joining one pair of edges a cylindrical shape is formed.

16. The reflective sleeve of claim 1 wherein the substrate is a woven fabric.

17. The reflective sleeve of claim 16 wherein the fabric is selected from mesh, canvas and vinyl film.

18. The reflective sleeve of claim 1 wherein the substrate is a nonwoven fabric.

19. The reflective sleeve of claim 1 further comprising a support selected from cones, drums, tubes, stakes, posts, coils, sign support, and traffic sign.

20. A roll-up sign comprising the sleeve of claim 1.

21. A method of making a reflective sleeve comprising
providing a flexible substrate that is triangular or rectangular in shape;
providing at least one reflective band; and
bonding the band to the flexible substrate.

22. The method of claim 21 wherein the reflective band is a transfer film.

23. The method of claim 22 wherein bonding is achieved by laminating the transfer film at a temperature ranging from about 150° C. to 200° C.

24. The method of claim 22 wherein the reflective transfer film consists essentially of a multitude of microspheres at least partially embedded in a binder layer and associated specular or diffuse reflecting material.

25. The method of claim 24 wherein the reflective band is substantially free of backing.

26. A method of making a reflective sleeve comprising
providing a flexible substrate;
providing at least one reflective band;
bonding the band to the flexible substrate forming a laminate; and
forming the laminate into a triangular or rectangular shape.
